(19) United States
(12) Patent Application Publication
(10) Pub. No.: US 2026/0119144 A1
(43) Pub. Date: Apr. 30, 2026

(54) TECHNIQUES FOR COMPILER LOWERING OF TASK-BASED PROGRAMS TO ASYNCHRONOUS ACCELERATORS

(71) Applicant: NVIDIA CORPORATION, Santa Clara, CA (US)

(72) Inventors: Rohan YADAV, Stanford, CA (US); Michael Edward BAUER, Seattle, WA (US); Michael GARLAND, Lake Elmo, MN (US); Alex AIKEN, Santa Clara, CA (US)

(21) Appl. No.: 19/263,050

(22) Filed: Jul. 8, 2025

Related U.S. Application Data
(60) Provisional application No. 63/713,908, filed on Oct. 30, 2024.

(51) Int. Cl. G06F 8/41

(52) U.S. Cl. CPC G06F 8/456

(57) ABSTRACT

A computer-implemented technique for compiling program code includes receiving first program code, generating a first dependence graph based on the first program code, removing one or more parallel loops in the first dependence graph to generate a second dependence graph, removing one or more copy operations from the second dependence graph to generate a third dependence graph, allocating memory to one or more data objects in the third dependence graph, assigning one or more sub-graphs of the third dependence graph to one or more corresponding warps, and generating second program code based on the one or more sub-graphs of the third dependence graph.

### CROSS-REFERENCE TO RELATED APPLICATIONS

This application claims priority benefit of the United States Provisional Patent Application titled, “TECHNIQUES FOR COMPILER LOWERING OF TASK-BASED PROGRAMS TO ASYNCHRONOUS ACCELERATORS IN STREAMING MULTIPROCESSORS,”filed on Oct. 30, 2024, and having Ser. No. 63/713,908. The subject matter of this related application is hereby incorporated herein by reference.

### BACKGROUND

### Field of the Various Embodiments

Embodiments of the present disclosure relate generally to computer science, compilers, and, more specifically, to techniques for compiler lowering of task-based programs to asynchronous accelerators.

### Description of the Related Art

Modern processing units employ parallel processing in complex computation tasks. Recent advances in graphics processing unit (GPU) architectures include the addition of specialized, fixed-function units, such as tensor cores within streaming multiprocessors (SMs) to perform specialized operations, including matrix multiplication. In addition, some GPU architectures feature asynchronous data transfer units, which transmit data without stopping or slowing down ongoing computations, allowing concurrent processing of multiple operations. Certain GPU architectures include dedicated matrix multiplication hardware in close physical proximity to other processing cores in SMs, which is also referred to as co-location. Co-locating specialized hardware modules within SMs improves overall computation speed.

One approach for managing complex computer programs is to use task-based programming models to divide the program into smaller units called tasks, each performing a particular portion of the program. Task-based programming models offer abstractions that separate computations into independently schedulable tasks operating on large data structures, such as tensors or arrays. Such programming models simplify certain aspects of writing parallel code by avoiding manually controlling when each task runs or how data moves between different modules.

One type of conventional programming system, referred to as low-level compilers, requires a user to manually write code for every single step involved in running parts of a program at the same time and handling the movement of data between different parts of the program that can execute asynchronously, without waiting for each other to complete. The manually written code can then be compiled by a low-level compiler and executed on a computing system. In other words, the user manually controls when each independent task starts and how the data is passed between different parts of the program. A drawback associated with low-level compilers is the necessity to perform extensive manual programming and management, which can be labor intensive and time consuming.

Another type of conventional programming system, referred to as high-level compilers, takes a different approach by using a compiler to automatically translate program code into instructions that manage the independent operations and the sharing of data between different parts of a program that can execute asynchronously. Although high-level compilers simplify the programming process, a user has less control over the detailed processing of the program. A drawback of high-level compilers is that the instructions generated by high-level compilers may not schedule the instructions or move the data in an efficient manner, which can lead to less optimal performance.

As the foregoing illustrates, what is needed in the art are more effective techniques for compiling program code.

### SUMMARY

One embodiment sets forth a method for compiling program code. The method includes receiving first program code, and generating a first dependence graph based on the first program code. The method further includes removing one or more parallel loops in the first dependence graph to generate a second dependence graph, and removing one or more copy operations from the second dependence graph to generate a third dependence graph. The method also includes allocating memory to one or more data objects in the third dependence graph, and assigning one or more sub-graphs of the third dependence graph to one or more corresponding warps. In addition, the method includes generating second program code based on the one or more sub-graphs of the third dependence graph.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques over prior approaches is that the disclosed techniques reduce the need for developers to manually manage asynchronous operations and communications within a processor. At the same time, the disclosed techniques enable task-based programming, in which programs are written as sets of designated functions, thereby providing developers with a higher degree of control over how code executes than is permitted by conventional high-level compilers. As a result, developers can focus on applications and objectives at a higher abstraction level, while still achieving performance close to hardware limits. Yet another technical advantage is that the disclosed techniques simplify the computational overhead associated with resource allocation and synchronization in programming. By mapping computations onto hardware resources and handling synchronization, computational loads can be reduced and better preserved for application-specific tasks. By placing synchronization points and data copy instructions, the disclosed techniques reduce low-level coordination burdens and accelerate integration with specialized hardware architectures through selective partitioning or warp assignments. As a result, the disclosed techniques enhance code reliability and improve overall execution efficiency compared to prior art approaches. These technological advantages represent one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the present embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 illustrates sequential stages of a compiler, according to various embodiments;

FIG. 5A illustrates an exemplar of a dependence graph and an associated dataflow intermediate code snippet, according to various embodiments;

FIG. 5B illustrates an exemplar transformation performed during a vectorization pass, according to various embodiments;

FIG. 5C illustrates an exemplar set of copy elimination patterns, according to various embodiments;

FIG. 6 is a flow diagram of method steps for compiling high-level task-based program code into optimized low-level code, according to various embodiments; and

FIG. 7 is a flow diagram of method steps for vectorizing nested parallel loops, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for translating task-based programs into code that is optimized for execution on asynchronous accelerators within a processor. In some embodiments, a compiler identifies data dependencies within program code, performs a vectorization pass to flatten nested loops to improve parallelism, and arranges computations and data transfers into streamlined pipelines. First, the compiler performs dependence analysis to construct a directed graph that encodes read-write relationships, memory placements, and required ordering among tasks. The compiler performs vectorization using the directed graph to eliminate parallel loops by converting iterative constructs into explicit references for thread or warp-level concurrency. The compiler performs copy elimination to remove and/or merge redundant data transfers, minimizing unnecessary data movement. Then, the compiler performs resource allocation to assign physical memory addresses to logical data structures according to constraints specified by a user. Thereafter, the compiler performs warp specialization to subdivide the directed graph across multiple warps, introduce synchronization points when necessary, and designate particular warps to invoke fixed-function accelerators for matrix multiplication or data movement. Finally, the compiler performs code generation from the subdivided directed graph to produce code including a sequence of operations, integrating relevant library calls and synchronization instructions, while maintaining near-peak utilization of available hardware resources.

The techniques of the present disclosure can be applied to compile any suitable task-based programs. For example, the disclosed techniques can be applied to compile task-based programs for various parallel workloads, including but not limited to linear algebra kernels (e.g., general matrix multiply), attention mechanisms (e.g., Flash Attention), and other tensor-algebra operations that benefit from asynchronous accelerators.

The above examples are not in any way intended to be limiting. As persons skilled in the art will appreciate, as a general matter, the compiling techniques described herein can be implemented in any application where translating task-based programs into optimized code for running on asynchronous accelerators is required or useful.

### System Overview

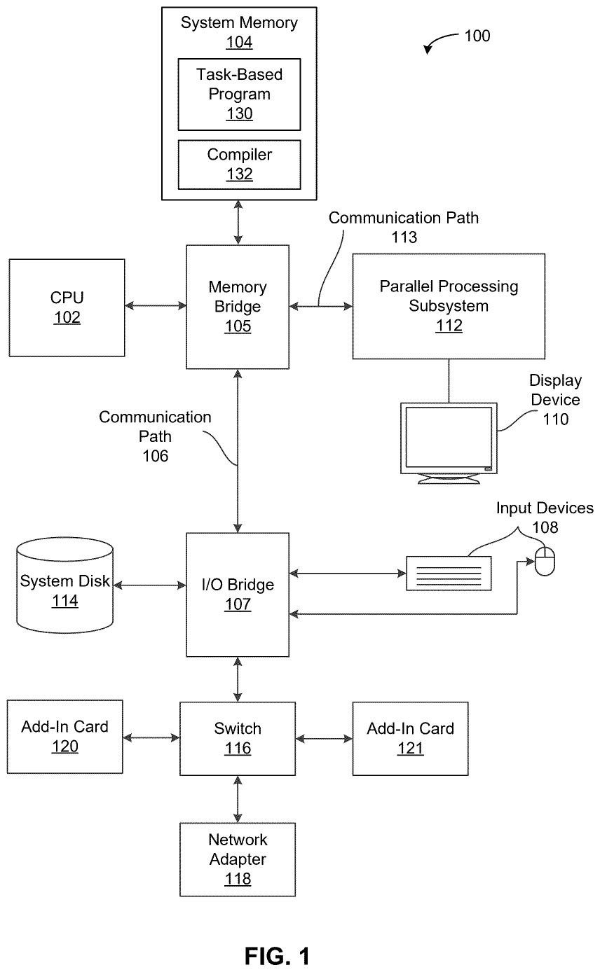

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, the computer system 100 is a server machine operating in a data center or a cloud computing environment that provides scalable computing resources as a service over a network.

In various embodiments, the computer system 100 includes, without limitation, a central processing unit (CPU) 102 and a system memory 104 coupled to a parallel processing subsystem 112 via a memory bridge 105 and a communication path 113. The memory bridge 105 is further coupled to an I/O (input/output) bridge 107 via a communication path 106, and the I/O bridge 107 is, in turn, coupled to a switch 116.

In one embodiment, the I/O bridge 107 is configured to receive user input information from optional input devices 108, such as a keyboard or a mouse, and forward the input information to CPU 102 for processing via the communication path 106 and the memory bridge 105. In some embodiments, the computer system 100 may be a server machine in a cloud computing environment. In such embodiments, the computer system 100 may not have the input devices 108. Instead, the computer system 100 may receive equivalent input information by receiving commands in the form of messages transmitted over a network and received via the network adapter 118. In one embodiment, the switch 116 is configured to provide connections between the I/O bridge 107 and other components of the computer system 100, such as a network adapter 118 and various add-in cards 120 and 121.

In one embodiment, the I/O bridge 107 is coupled to a system disk 114 that may be configured to store content and applications and data for use by the CPU 102 and the parallel processing subsystem 112. In one embodiment, the system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 107 as well.

In various embodiments, the memory bridge 105 may be a Northbridge chip, and the I/O bridge 107 may be a Southbridge chip. In addition, the communication paths 106 and 113, as well as other communication paths within the computer system 100, may be implemented using any technically suitable protocols, including, without limitation, AGP (Accelerated Graphics Port), HyperTransport, or any other bus or point-to-point communication protocol known in the art.

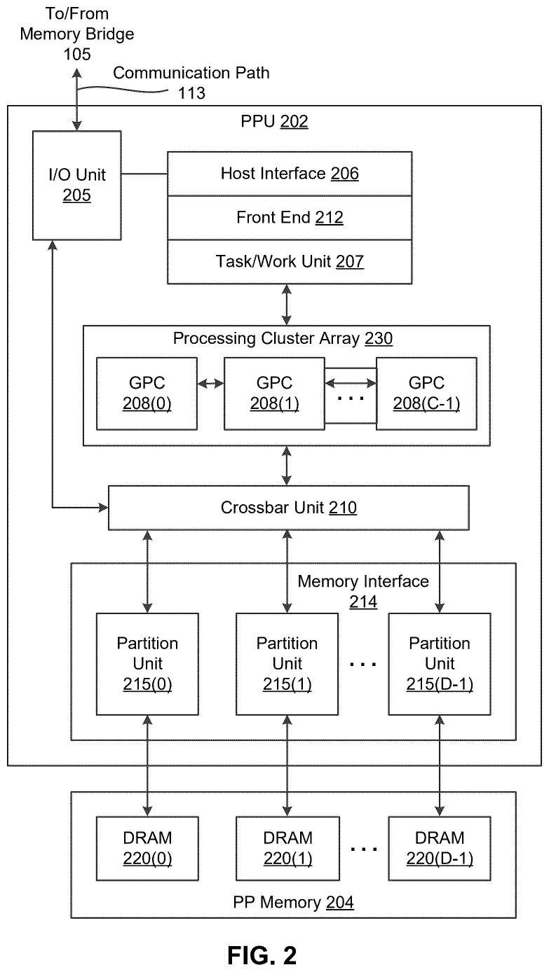

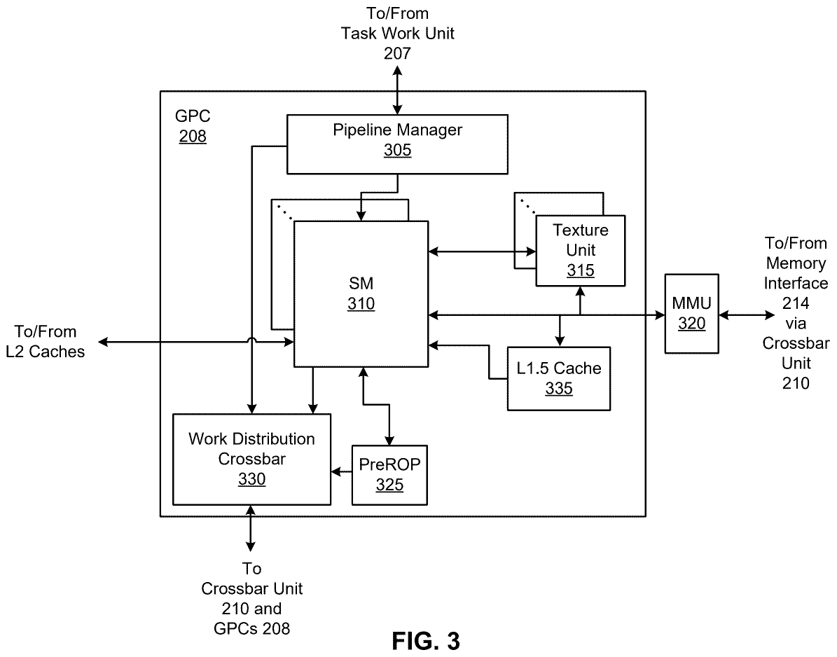

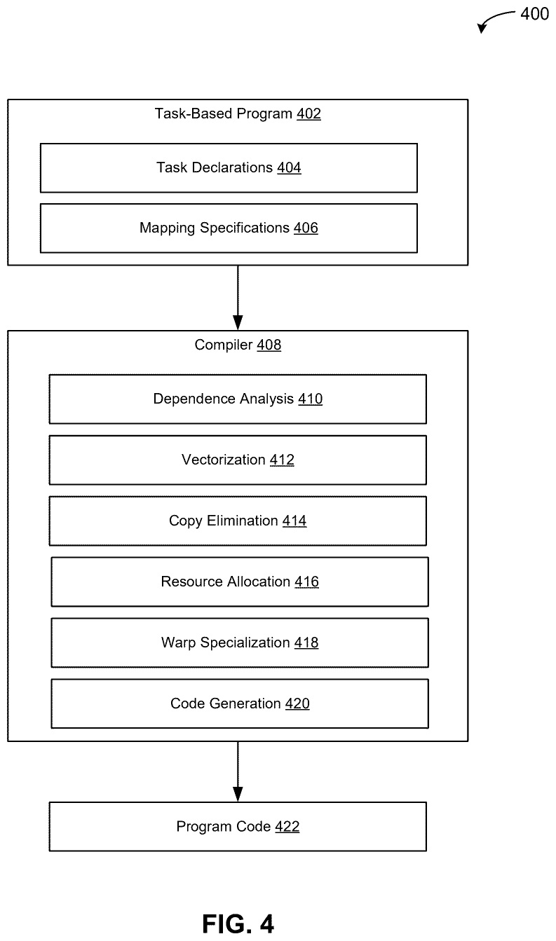

In some embodiments, the parallel processing subsystem 112 comprises a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within the parallel processing subsystem 112. In other embodiments, the parallel processing subsystem 112 incorporates circuitry optimized for general purpose and/or compute processing. Again, such circuitry may be incorporated across one or more PPUs included within the parallel processing subsystem 112 that are configured to perform such general purpose and/or compute operations. In yet other embodiments, the one or more PPUs included within the parallel processing subsystem 112 may be configured to perform graphics processing, general purpose processing, and compute processing operations. The system memory 104 includes a task-based program 130 that includes high-level instructions for managing computations performed by one or more PPUs within the parallel processing subsystem 112. The task-based program 130 can be any technically feasible application that expresses computations in terms of tasks and data partitions. For example, the task-based program 130 could specify a general matrix-multiply (GEMM) operation or an attention mechanism (e.g., Flash Attention) for a machine-learning workload. In addition, the system memory 104 includes a compiler 132. The compiler 132 is configured to generate low-level program code from the task-based program 130 using the techniques disclosed herein, as described in greater detail below in conjunction with FIG. 4-7. Although described herein primarily with respect to the task-based program 130 and the compiler 132, techniques disclosed herein can also be implemented, either entirely or in part, in other software and/or hardware, such as in the parallel processing subsystem 112.

In various embodiments, the parallel processing subsystem 112 may be integrated with one or more of the other elements of FIG. 1 to form a single system. For example, the parallel processing subsystem 112 may be integrated with the CPU 102 and other connection circuitry on a single chip to form a system on chip (SoC).

In one embodiment, the CPU 102 is the master processor of the computer system 100, controlling and coordinating operations of other system components. In one embodiment, the CPU 102 issues commands that control the operation of PPUs. In some embodiments, the communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, the system memory 104 could be connected to the CPU 102 directly rather than through the memory bridge 105, and other devices would communicate with the system memory 104 via the memory bridge 105 and the CPU 102. In other embodiments, the parallel processing subsystem 112 may be connected to the I/O bridge 107 or directly to the CPU 102, rather than to the memory bridge 105. In still other embodiments, the I/O bridge 107 and the memory bridge 105 may be integrated into a single chip instead of existing as one or more discrete devices. In certain embodiments, one or more components shown in FIG. 1 may not be present. For example, the switch 116 could be eliminated, and the network adapter 118 and the add-in cards 120, 121 would connect directly to the I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in some embodiments. For example, the parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in the parallel processing subsystem 112 of FIG. 1, according to various embodiments. Although FIG. 2 depicts one PPU 202, as indicated above, parallel processing subsystem 112 may include any number of PPUs 202. As shown, the PPU 202 is coupled to a local parallel processing (PP) memory 204. The PPU 202 and PP memory 204 may be implemented using one or more integrated circuit devices, such as programmable processors, application specific integrated circuits (ASICs), or memory devices, or in any other technically feasible fashion.

In some embodiments, the PPU 202 comprises a GPU that may be configured to implement a graphics rendering pipeline to perform various operations related to generating pixel data based on graphics data supplied by the CPU 102 and/or system memory 104. When processing graphics data, the PP memory 204 can be used as graphics memory that stores one or more conventional frame buffers and, if needed, one or more other render targets as well. Among other things, the PP memory 204 may be used to store and update pixel data and deliver final pixel data or display frames to an optional display device 110 for display. In some embodiments, the PPU 202 also may be configured for general-purpose processing and compute operations. In some embodiments, the computer system 100 may be a server machine in a cloud computing environment. In such embodiments, the computer system 100 may not have a display device 110. Instead, the computer system 100 may generate equivalent output information by transmitting commands in the form of messages over a network via the network adapter 118.

In some embodiments, the CPU 102 is the master processor of computer system 100, controlling and coordinating operations of other system components. In one embodiment, the CPU 102 issues commands that control the operation of the PPU 202. In some embodiments, the CPU 102 writes a stream of commands for the PPU 202 to a data structure (not explicitly shown in either FIG. 1 or FIG. 2) that may be located in the system memory 104, the PP memory 204, or another storage location accessible to both the CPU 102 and the PPU 202. A pointer to the data structure is written to a command queue, also referred to herein as a pushbuffer, to initiate processing of the stream of commands in the data structure. In one embodiment, the PPU 202 reads command streams from the command queue and then executes commands asynchronously relative to the operation of the CPU 102. In embodiments where multiple pushbuffers are generated, execution priorities may be specified for each pushbuffer by an application program via device driver to control scheduling of the different pushbuffers.

In one embodiment, the PPU 202 includes an I/O (input/output) unit 205 that communicates with the rest of the computer system 100 via the communication path 113 and the memory bridge 105. In one embodiment, I/O unit 205 generates packets (or other signals) for transmission on the communication path 113 and also receives all incoming packets (or other signals) from the communication path 113, directing the incoming packets to appropriate components of the PPU 202. For example, commands related to processing tasks may be directed to a host interface 206, while commands related to memory operations (e.g., reading from or writing to PP memory 204) may be directed to a crossbar unit 210. In one embodiment, the host interface 206 reads each command queue and transmits the command stream stored in the command queue to a front end 212.

As mentioned above in conjunction with FIG. 1, the connection of the PPU 202 to the rest of the computer system 100 may be varied. In some embodiments, the parallel processing subsystem 112, which includes at least one PPU 202, is implemented as an add-in card that can be inserted into an expansion slot of the computer system 100. In other embodiments, the PPU 202 can be integrated on a single chip with a bus bridge, such as the memory bridge 105 or the I/O bridge 107. Again, in still other embodiments, some or all of the elements of the PPU 202 may be included along with the CPU 102 in a single integrated circuit or system of chip (SoC).

In one embodiment, the front end 212 transmits processing tasks received from the host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from the front end 212 and ensures that general processing clusters (GPCs) 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, the PPU 202 implements a highly parallel processing architecture based on a processing cluster array 230 that includes a set of C GPCs 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of the PP memory 204.

In one embodiment, a given GPC 208 may process data to be written to any of the DRAMs 220 within the PP memory 204. In one embodiment, the crossbar unit 210 is configured to route the output of each GPC 208 to the input of any partition unit 215 or to any other GPC 208 for further processing. The GPCs 208 communicate with the memory interface 214 via the crossbar unit 210 to read from or write to various DRAMs 220. In some embodiments, the crossbar unit 210 has a connection to the I/O unit 205, in addition to a connection to the PP memory 204 via the memory interface 214, thereby enabling the processing cores within the different GPCs 208 to communicate with the system memory 104 or other memory not local to the PPU 202. In the embodiment of FIG. 2, the crossbar unit 210 is directly connected with the I/O unit 205. In various embodiments, the crossbar unit 210 may use virtual channels to separate traffic streams between the GPCs 208 and the partition units 215.

In one embodiment, the GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, the PPU 202 is configured to transfer data from the system memory 104 and/or the PP memory 204 to one or more on-chip memory units, process the data, and write result data back to the system memory 104 and/or the PP memory 204. The result data may then be accessed by other system components, including the CPU 102, another PPU 202 within the parallel processing subsystem 112, or another parallel processing subsystem 112 within the computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, the GPC 208 includes, without limitation, a pipeline manager 305, one or more texture units 315, a preROP unit 325, a work distribution crossbar 330, and an L1.5 cache 335.

In one embodiment, the GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of the GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, the GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. In some embodiments, a thread group can be implemented as a vector instruction or SIMD operation on hardware supporting vector processing. Thread groups include, without limitation, GPU warps, vector lanes, or any hardware-accelerated group of execution units that run the same program on different input data concurrently. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array. ” The size of a particular CTA is equal to m*k, where k is the number of concurrently executing threads in a thread group, which is typically an integer multiple of the number of execution units within the SM 310, and m is the number of thread groups simultaneously active within the SM 310. In some embodiments, a single SM 310 may simultaneously support multiple CTAs, where such CTAs are at the granularity at which work is distributed to the SMs 310.

In one embodiment, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Compiler Lowering of Task-basked Programs to Asynchronous Accelerators

FIG. 4 illustrates sequential stages of a compiler 400 for compiling a task-based program 402 into program code suitable for execution on a graphics processing unit (GPU) or other compatible processors, according to various embodiments. Task-based program 402 includes task declarations 404, which define operations on tensors or other data collections, and mapping specifications 406, which guide placement and parallelization of tasks onto hardware resources. Compiler 408 includes a dependence analysis module 410 (“dependence analysis 410”), a vectorization module 412 (“vectorization 412), a copy elimination module 414 (“copy elimination 414”), a resource allocation module 416 (“resource allocation 416”), a warp specialization module 418 (“warp specialization 418”), and a code generation module 420 (“code generation 420”). Program code 422 generated from compiler 408 is code in a low-level programming language capable of invoking specialized hardware units, such as general processing cluster GPC 208 or streaming multiprocessor SM 310 within the parallel processing unit PPU 202. For example, program code 422 could be Compute Unified Device Architecture (CUDA) C++ code, NVVM code, or any other program code in a low-level programming level.

Task-based program 402 includes a high-level program in terms of discrete, sequential, or parallel tasks that operate on data, such as tensors. Although described herein primarily with respect to tensors as a reference example, techniques disclosed herein can be applied to any suitable data in some embodiments. Task-based program 402 can include various operations, such as matrix multiplications, element transformations, and/or data movement. In some embodiments, task-based program 402 is designed to preserve sequential semantics at a high level, while still permitting parallel scheduling or specialization of tasks when mapped to hardware resources such as GPC 208 and/or SM 310. In some embodiments, each task in task-based program 402 can include input-output requirements, tensor dimensions, and/or data access privileges, enabling generation of a dependence graph among tasks. Each element of task-based program 402 can be associated with processor or memory resources, including one or more warps, thread blocks, specialized compute units, and/or GPCs 208 in a multi-cluster environment, along with a selection of memory regions such as global memory, shared memory, and/or registers.

Task declarations 404 includes a set of operations and/or functions describing tensor-based computations, such as matrix multiplications, element operations, data movement, and/or other numerical transformations. Each declared task in task declarations 404 can include one or more input tensors, one or more output tensors, and a defined operation that transforms data from the inputs to the outputs. In some embodiments, task declarations 404 can indicate data access privileges (e.g., read, write, or read-write), specify shape or precision details for tensors, and/or designate whether a task is leaf-level (capable of directly reading or writing data) or inner-level (configured to launch additional sub-tasks). In some embodiments, inner-level tasks can launch sub-tasks either sequentially, by using an srange operation over an iteration domain, or in parallel, by using a prange operation that ensures non-conflicting writes to underlying tensors. Task declarations 404 can also incorporate multiple variants of a task, each potentially targeting different processors or employing distinct algorithms. By expressing computations exclusively through task declarations 404, application logic remains decoupled from low-level platform details, which promotes flexible adaptation or expansion of the program for new hardware configurations or evolving performance requirements.

Mapping specifications 406 define a set of rules or directives indicating how tasks and associated data structures are bound to particular processing or memory resources in a hardware architecture. Each input in mapping specifications 406 can reference a processor level, such as a host, block, warpgroup, warp, or thread, and can specify a memory region, such as global memory, shared memory, register memory, or none, for a given tensor allocation. By assigning tasks to a specific processor level, mapping specifications 406 enable selective utilization of specialized hardware units, for example, asynchronous data movers or specialized matrix multiplication engines. Additional parameters, including partition sizes, pipeline depths, and/or warp specialization directives, can further refine concurrency, reuse patterns, and/or resource allocation during compilation.

In some embodiments, mapping specifications 406 represent a hierarchy of task-mapping objects (or an instance), where each object identifies (i) the task variant selected for a processor level, (ii) the processor that executes the task, (iii) the memory placement for each tensor, (iv) a set of tunable values, and (v) a reference to a subsequent mapping object for sub-task dispatch. Mapping specifications 406 can incorporate constraints that restrict materialization of certain tensors within particular memories, for instance by designating the none memory to mandate strictly partitioned. For example, such designations can prevent an entire tensor from occupying a large memory space, ensuring that only partitioned tiles reside in shared memory or registers. By separating performance-sensitive directives in mapping specifications 406 from the logical definitions in task declarations 404, a program can adapt to evolving hardware configurations while preserving correctness and ensuring that static scheduling, data placement, and concurrency settings remain under user or automated control.

Compiler 408 is configured to receive a high-level, task-based program 402 including task declarations 404 and mapping specifications 406, and generate warp-specialized program code (for example, CUDA C++ code), with explicit data movement and synchronization. Compiler 408 can be implemented as a collection of transformation passes that analyze the task declarations 404 and mapping specifications 406 in order to perform dependence analysis 410, vectorization 412, copy elimination 414, resource allocation 416, warp specialization 418, and code generation 420 for distinct processor groupings. In some embodiments, compiler 408 adopts a statically scheduled approach that circumvents the overhead of dynamic runtime systems. Compiler 408 performs sequential transformations on an internal representation of tasks and data dependencies, ensuring that the final generated code preserves the sequential semantics declared in the task-based program 402 while exploiting available concurrency on the hardware architecture.

Various embodiments utilize an intermediate representation (IR) that encodes both computation and dataflow events for the task-based program. The IR can include constructs denoting explicit copies between tensor allocations, sequential and parallel iteration loops, and asynchronous invocations of tasks. Each asynchronous operation, such as a leaf-level task invocation or a copy directive, can produce an event indicating completion. The IR associates precondition events with each asynchronous operation to ensure that dependencies on previously declared reads or writes are satisfied, thereby forming a static dependence graph. For example, for and pfor operators could operate on loop blocks that yield completion events, and scalar operations could remain outside event tracking to avoid unnecessary overhead.

Compiler 408 processes the IR in multiple transformation passes, preserving and refining event-based dependencies in a single-static-assignment (SSA)-style framework that prevents read/write conflicts. Event arrays, annotated with processor kinds, allow the compiler to broadcast completion signals across entire warps, blocks, or thread sets, ensuring correct synchronization when parallel tasks generate or consume shared data. Because events remain an intermediate construct, compiler 408 eventually replaces events with synchronization instructions (e.g., named barriers, warp-level intrinsics) during code generation, without incurring any dynamic overhead at runtime.

In various embodiments, an event refers to a construct within an IR that denotes the completion of an operation on a particular processor, such as a copy command or a leaf-level task invocation. Each event can be associated with a set of precondition events, indicating that the corresponding operation does not begin until all preconditions complete. Consequently, an event forms a node or node-like structure in a dependence graph, capturing the flow of data and execution ordering in a statically scheduled manner. An event can also appear in an event array, where each element corresponds to a different processor or iteration, enabling synchronized completion tracking across multiple parallel tasks. Once an operation finishes, the resulting event serves as a signal for subsequent operations.

Dependence analysis 410 translates each of the task declarations 404 and mapping specifications 406 inputs in task-based program 402 into an event-based IR. The dependence analysis 410 tracks a tree of task invocations in an in-order manner, identifying both true dependencies (read-after-write) and anti-dependencies (write-after-read) for share data objects such as tensors by examining read, write, or read-write privileges declared within the tasks. When multiple tasks share one or more tensors, dependence analysis 410 connects the relevant events to enforce correct ordering among producers and consumers. In addition, dependence analysis 410 generates copy operations to maintain coherence between mappings of the same tensor in different memory locations, creating a copy-in/copy-out scheme at each task boundary. Furthermore, dependence analysis 410 constructs a chain of completion signals for each tensor in the task tree, thereby structuring the IR in a manner that facilitates parallelism and prevents data hazards.

In some embodiments, the copy-in/copy-out scheme is defined by a sequence of operations that allocate, transfer, and reconcile data buffers for an invoked task (callee task) in an IR. First, dependence analysis 410 creates a new allocation for each tensor argument designated for the callee task, placing the allocation in a memory specified by mapping specifications 406. Next, dependence analysis 410 directs a copy from an existing tensor allocation into the new allocation for every tensor argument that is subject to read privileges, while registering event dependencies for concurrency management. After that, dependence analysis 410 collects all completion events from the copy operations and assigns completion events as preconditions for the callee task, followed by a recursive generation of an IR. Finally, dependence analysis 410 generates a copy operation from the new allocation back to the original tensor buffer for each tensor argument that requires write privileges, controlled by the completion event of the callee task to ensure correct sequencing and data consistency.

In some embodiments, a task tree can define tasks that map to different memory locations, for example, shared memory for partial accumulations (e.g., on-chip memory in SMs 310) and global memory (e.g., system memory 104) for final outputs. Dependence analysis 410 generates copy commands in the IR to preserve valid read and write privileges in the mapped tasks and maintains declared sequential logic. The copy-in/copy-out scheme can lead to redundant data transfers when a consumer is already able to reference data in shared memory. A subsequent pass, such as a copy elimination 414, can remove redundant copy operations and discard the associated synchronization requirements.

Vectorization 412 removes nested parallel loops that are implicit in a GPU programming model, including pfor constructs distributed across processor groups such as warpgroups, warps, or threads. The transformation employs indexable event arrays to preserve dependencies and shared synchronization between parallel iterations. The process begins by locating the deepest parallel loops generated by dependence analysis 410 and substituting iteration variables with expressions that evaluate to hardware-specific processor identifiers such as the warp or thread index. Once implicit loops are flattened, each array of events is promoted by adding a new dimension sized to match the extent of the flattened loop, thereby indexing each array of events according to the processor index. The resulting array of events structure enables distinct tasks in separate iterations to continue operating with local dependencies, while shared dependencies are maintained for synchronization.

During the flattening process, point-wise dependencies remain intact. Such point-wise dependencies refer to ordering or synchronization constraints that apply to individual iterations or lanes of a parallel operation, ensuring that each iteration can proceed independently when no data hazards exist. Broadcast operators, which function as synchronization constructs or indexing mechanisms that coordinate events or data across all parallel iterations in a loop, are introduced for any collective operations or shared data resources that mandate a barrier across iterations. By encoding each iteration index directly, vectorization 412 simplifies code generation and clarifies concurrency paths within the IR. The final representation retains explicit references to event-based synchronization, enabling subsequent compiler passes, such as copy elimination 414 or resource allocation 416, to operate on a fully flattened set of tasks without revisiting implicit loops.

Copy elimination 414 identifies and removes redundant copy operations introduced by a copy-in/copy-out scheme generated by dependence analysis 410. The copy elimination 414 applies a set of rewrite patterns that removes or moves copies. In some embodiments, users are allowed to specify the elimination of copies to and from some tensor instances. The copy elimination 414 analyzes IR derived from earlier stages, locating pairs of copy that impose inefficiencies. By eliminating unnecessary transfers, copy elimination 414 reduces memory bandwidth usage, shortens critical paths for data movement, and improves overall performance.

In some embodiments, copy elimination 414 utilizes different patterns to remove redundant copy operations. In some embodiments, one pattern merges redundant copies into a single operation, preventing duplicate transfers from occupying shared or global memory. In such cases, another pattern, referred to as spill elimination, identifies instances in which a parent buffer slice is immediately transferred back to a child buffer. Copy elimination 414 removes or relocates copy operations outside loop constructs, provided the underlying data remains unchanged. Furthermore, in some embodiments, a self-copy elimination pattern bypasses transfers that rewrite the same buffer with no updates, but ensures that any event arrays governing synchronization remain valid. For instance, an entire warpgroup can move data from register-level allocations to shared memory for a specialized accelerator. Certain synchronization steps must remain intact to guarantee that all threads complete data transfers before proceeding.

Copy elimination 414 leverages the structure of event arrays to reconcile dependencies that are removed with the associated copy operations. If a copy is no longer relevant, any synchronization implied solely by that copy can be eliminated, preserving only the point-wise or broadcasted dependencies essential for correctness. Ordering of patterns in the rewrite process can be important. Certain copy eliminations that remove events entirely are applied first. Patterns that maintain dependencies are applied next, ensuring that any partially shared data structures remain coherent. Additional frameworks, such as equality saturation, can be employed to discover further optimizations that reduce memory overhead or synchronization costs within the compiler pipeline.

Resource allocation 416 determines how remaining tensors are mapped onto physical memory addresses following copy elimination 414. Resource allocation 416 can target shared memory within each streaming processor, recognizing that shared memory imposes strict capacity constraints. A primary consideration involves balancing the demands of memory pressure against the benefits of parallelism, which requires a selection of logical tensors for shared or overlapping addresses. In some embodiments, shared memory usage corresponds to SRAM regions within SM 310, with data movement managed through crossbar unit 210 to PP memory 204 and DRAM 220. In addition, a certain level of aliasing can be used to accommodate large tiles required by specialized units, yet excessive aliasing can degrade performance by limiting concurrency.

Resource allocation 416 receives a user-defined upper bound for shared memory usage at the thread block level. Resource allocation 416 constructs an interference graph in which nodes represent shared memory tensors, and edges denote conflicts preventing simultaneous usage of the same storage block. Additional edges are appended to create a complete graph, forcing every tensor into a discrete allocation. The allocation procedure gradually removes specific auxiliary edges from the interference graph to reduce unnecessary exclusivity, then searches for an arrangement fitting the memory limit. If no feasible allocation emerges, resource allocation 416 reports an out-of-memory condition, prompting adjustments in the mapping specification. Once a valid strategy is found, resource allocation 416 inserts event dependencies to ensure that tensors sharing the same physical address do not overlap, thereby preventing write-after-read hazards.

Warp specialization 418 can partition computations within a single thread block across multiple warps, thereby exposing concurrency and allocating hardware resources more effectively. Warp specialization 418 can receive instructions from mapping specifications 406 to separate compute tasks from data movement tasks, preventing interference between asynchronous fixed-function units such as a tensor memory accelerator and a tensor core. The compiler 408 manages warp specialization 418 as a graph partitioning step, assigning global-to-shared memory copies to a dedicated data movement warp while assigning other operations to one or more compute warps. Any cross-partition edges show synchronization points enforced through explicit barriers, ensuring that data is consistently transferred and consumed without conflict.

Warp specialization 418 can further support pipelining transformations to avoid exposed global memory access latency. A selected pipeline depth unrolls loop structures in the dependence graph, indexing each pipelined buffer element modulo the specified depth. The data movement warp can advance multiple loop iterations ahead of the compute warps, preloading tiles into shared memory or register sets and mitigating idle cycles. Backward edges are inserted where asynchronous copies must wait for consumers of previously loaded buffers, preventing write-after-read hazards. The end result integrates deeper concurrency with controlled synchronization, reducing register pressure and instruction cache footprint relative to conventional unrolling strategies.

Code generation 420 manages generation of program code, such as C++ constructs that encapsulate functionalities, along with required synchronization or data structures identified in task-based program 402 and translated events from the IR. In some embodiments, the IR can be lowered onto hardware-specific synchronization primitives on a GPU. The generated code can include outlining device functions, defining specialized templates, and handling warp-specialization barriers in a manner consistent with the IR event-based synchronization. Code generation 420 ensures that logical operations, partitioned tasks, and prepared data transfers are all expressed as code suitable for producing valid kernels (e.g., CUDA kernels) to execute on GPU architectures.

Program code 422 implements the final kernel launches, global functions, and hardware-specific intrinsics. Shared memory barriers, named barrier operations, or warp-level synchronization mechanisms based on the events established by code generation 420. Tensor allocations mapped to global or shared memory determined by mapping specifications 406 are managed through constructs of a programming language, such as CUDA. For example, the fully generated code could combine C++ logic with CUDA-specific features, providing a statically scheduled, optimized implementation of the original task-based description.

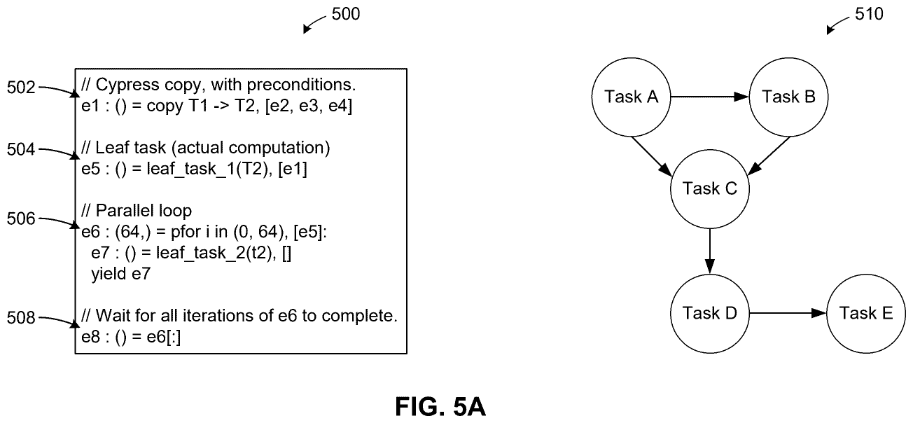

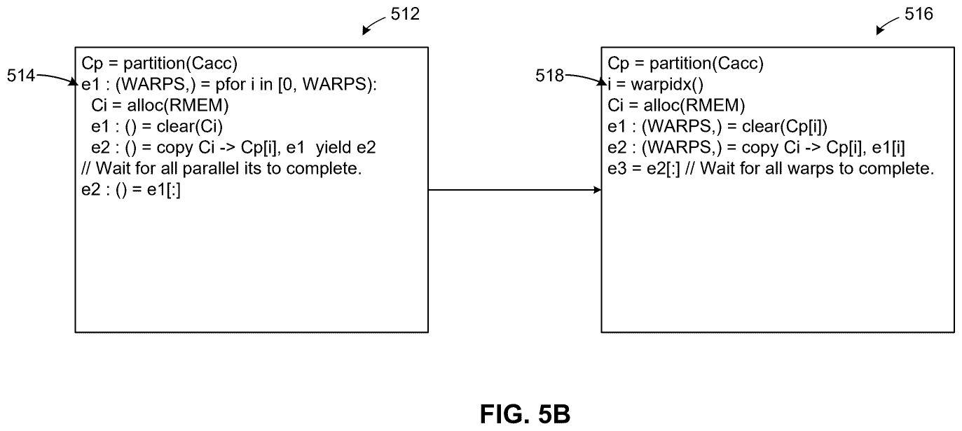

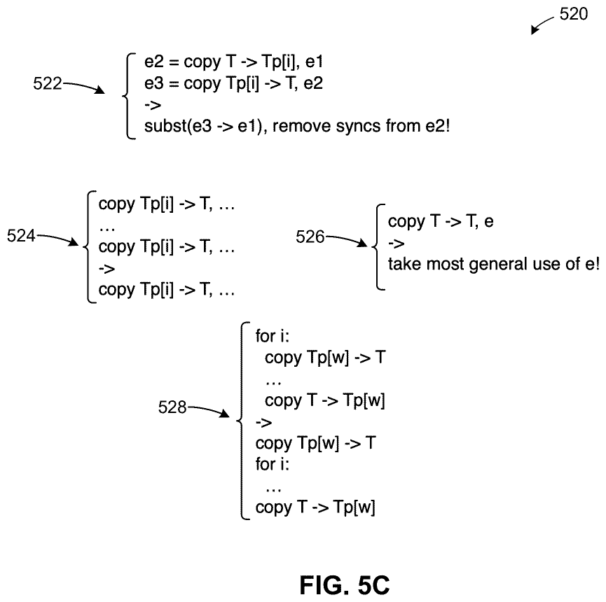

FIG. 5A illustrates an exemplar of a dependence graph 510 and associated dataflow intermediate code snippet 500 generated during dependence analysis 410 pass. The code snippet 500 includes multiple lines 502, 504, 506, and 508, each reflecting a distinct operation, task, or loop in the IR.

Code snippet 500 demonstrates how dependence analysis 410 arranges a set of tasks with explicit event preconditions and synchronized conclusions. Line 502 shows a copy command transferring data from T1 to T2, governed by event preconditions e2, e3, and e4. The explicit copy instruction demonstrates a copy-in/copy-out scheme generated by dependence analysis 410, ensuring that read-after-write or write-after-read relationships are respected before data is moved. In scenarios where data is mapped to multiple memories (for example, shared memory for partial accumulations and global memory for final outputs), such a copy ensures that T2 contains valid data only after e2, e3, and e4 complete.

Next, in line 504 a leaf-level task e5 operates on tensor T2, subject to the completion of e1. The event e1 indicates a true dependency that prevents leaf_task_1 from executing until the preceding copy from line 502 finishes. Dependence analysis 410 generates the dependency to enforce sequential semantics, allowing leaf_task_1 to read T2 without risking data hazards. If T2 is overwritten in a later stage or used by subsequent parallel loops, the chain of completion signals remains consistent through e5.

Thereafter, line 506 states a pfor loop e6 with 64 parallel iterations, each receiving e5 as a precondition. Within each iteration, a leaf-level operation leaf_task_2(t2), marked as e7, executes independently. At the end of the pfor loop, yield e7 specifies that each iteration returns the event e7 as the output for that iteration. Each iteration can proceed concurrently once e5 completes, reflecting a point-wise dependency on the final outcome of leaf_task_1. Dependence analysis 410 employs parallel loops to harness concurrency across multiple threads or warps, thus enabling faster execution if no additional data conflicts arise among the 64 sub-tasks.

Subsequently, line 508 provides a broadcast index e8 that waits on the collective completion of e6. Line 508 unifies the result of all 64 parallel sub-tasks by indexing e6[:], thereby producing a final synchronization point for subsequent operations. In practice, any dependent task or leaf level command can reference e8 to ensure that every iteration of the parallel loop has finished, preventing write-after-read hazards or partial data exposure. Dependence analysis 410 attaches the broadcast indexing operator to guarantee a global barrier prior to a new task execution.

The dependence graph 510 provides a visualization of tasks and dependencies. Each rectangular box in element 510 (for example, Task A, Task B, Task C, Task D, and Task E) corresponds to a discrete operation derived from the task-based program 402. Edges or arrows linking boxes represent ordering constraints, meaning that a dependent task cannot begin until upstream operations have completed. Parallel paths at the same horizontal level reflect tasks that can potentially run concurrently. The top-down dependence graph 510 illustrates an overall flow, beginning with initial tasks and progressing to final tasks or synchronizations.

FIG. 5B illustrates an exemplar transformation performed during a vectorization pass. The first code snippet 512 with an original parallel loop is re-written by substituting iteration variables with hardware-specific indexes in the second code snippet 516. Vectorization 412 applies the transformation to remove nested loops, promote event arrays along newly introduced dimensions, and ultimately expose concurrency that aligns with GPU thread or warp identifiers.

In code snippet 512, line 514 declares pfor as a parallel loop that launches one iteration per warp. Each iteration allocates a register-memory buffer Ci, executes a clear operation on Ci, and then copies Ci into a partitioned section of Cacc identified by Cp[i]. Once all iterations conclude, event e2 ensures a broadcast synchronization across each warp.

In the code snippet 516, line 518 illustrates the result of vectorizing away the explicit pfor loop. Vectorization 412 locates the pfor construct in 512 and flattens the loop by directly substituting i in 514 with warpidx( ) in line 518. The flattening preserves point-wise dependencies among parallel tasks and introduces a broadcast operator to coordinate completion when necessary. The code snippet 516 uses line 518 to enable each warp to manage partial accumulations without requiring an implicit loop structure. A new event array, labeled e1, ensures concurrency across parallel calls to clear or copy operations, each subscripted by [i]. A final broadcast event e3, merges all warp-level events into a unified barrier, signaling readiness for subsequent passes or tasks. By making the warp dimension explicit, vectorization 412 simplifies code generation and clarifies concurrency paths, allowing further compiler steps such as copy elimination 414 or resource allocation 416 to handle a flattened representation without revisiting loop constructs.

FIG. 5C illustrates an exemplar set of copy elimination patterns. The code snippet 522 shows a sequence of two copy operations. A rewrite step by copy elimination 414 transforms copy operations by substituting references to e3 with e1, removing redundant synchronization produced by the initial pair of copies. The code snippet 522 demonstrates a pattern in which a parent buffer slice is directly copied back to a child buffer and then restored to the parent, prompting removal of both the second copy and the associated barrier events.

In another example, the code snippet 524 includes a copy from Tp[i] to T, repeated multiple times. Copy elimination 414 merges identical copies into a single call or removes subsequent duplicates when data remains unchanged. Such copy elimination can reduce unnecessary bandwidth usage in shared or global memory, particularly in loops that might replicate copy directives.

In yet another example, the code snippet 526 shows a self-copy, which triggers a removal pattern when the buffer source and destination refer to the same logical tensor. The copy elimination 414 employs analysis to determine that no actual data movement occurs, although synchronization can still be preserved if needed for correctness. Copy elimination 414 can eliminate the transfer when copy elimination 414 recognizes a true self-copy, while retaining dependencies required by other tasks.

In a further example, the code snippet 528 presents a loop that copies from Tp[w] to T, followed by a further copy from T to Tp[w]. The copy pattern is rewritten by hoisting or removing copies under the principle that a repeated cycle of reading and writing remains redundant if the source data are unchanged. The transformation rearranges the loop boundaries to maintain correctness for tasks that consume T or use Tp[w]. Copy elimination 414 thereby handles spills, self-copies, duplicates, or other repeated patterns, either preserving or eliminating dependencies as appropriate.

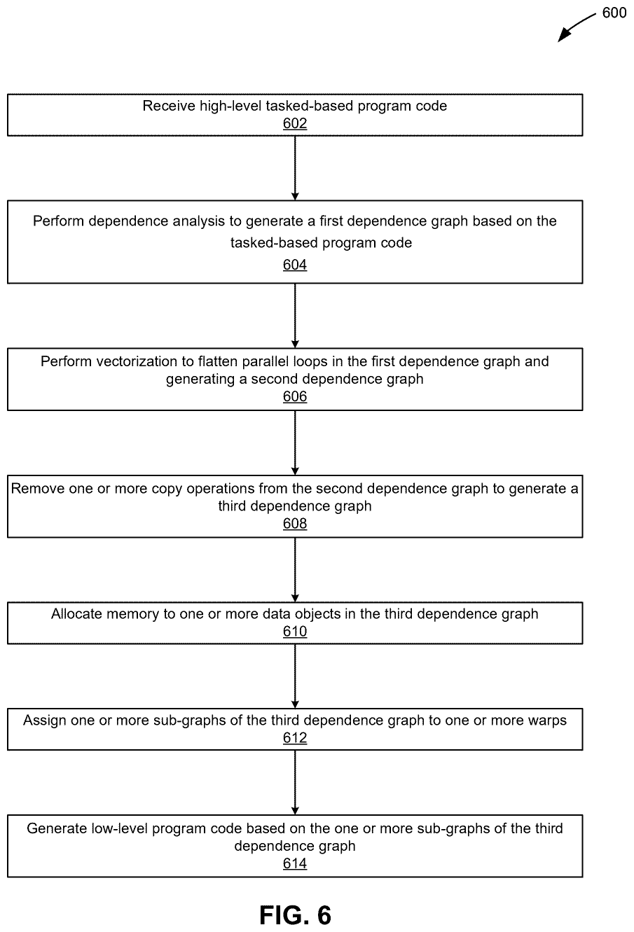

FIG. 6 is a flow diagram of a method 600 for compiling a high-level, task-based program into optimized code suitable for execution on a parallel processing unit or comparable architecture. Although the method steps are described in conjunction with the systems of FIGS. 1-4, persons skilled in the art will understand that any system configured to perform the method steps in any order falls within the scope of the present embodiments.

As shown, a method 600 begins with step 602, where compiler 132 receives high-level, task-based program code 402. As described, task-based program 402 can include task declarations 404 and mapping specifications 406 that describe operations on tensors and specify memory or processor assignments. The received task-based program code 402 can include input-output requirements, tensor dimensions, and/or data access privileges, enabling generation of a dependence graph among tasks. Each element of task-based program 402 can be associated with processor or memory resources, including one or more warps, thread blocks, specialized compute units, and/or GPCs 208 in a multi-cluster environment, along with a selection of memory regions such as global memory, shared memory, and/or registers.

At step 604, dependence analysis 410 translates each of the task declarations 404 and mapping specifications 406 inputs in task-based program 402 into an event-based IR and generates a first dependence graph. The dependence analysis 410 tracks a tree of task invocations in an in-order manner, identifying both true dependencies (read-after-write) and anti-dependencies (write-after-read) for share data objects such as tensors by examining read, write, or read-write privileges declared within the tasks. When multiple tasks share one or more tensors, dependence analysis 410 connects the relevant events to enforce correct ordering among producers and consumers. In addition, dependence analysis 410 generates copy operations to maintain coherence between mappings of the same tensor in different memory locations, creating a copy-in/copy-out scheme at each task boundary. Furthermore, dependence analysis 410 constructs a chain of completion signals for each tensor in the task tree, thereby structuring the IR in a manner that facilitates parallelism and prevents data hazards.

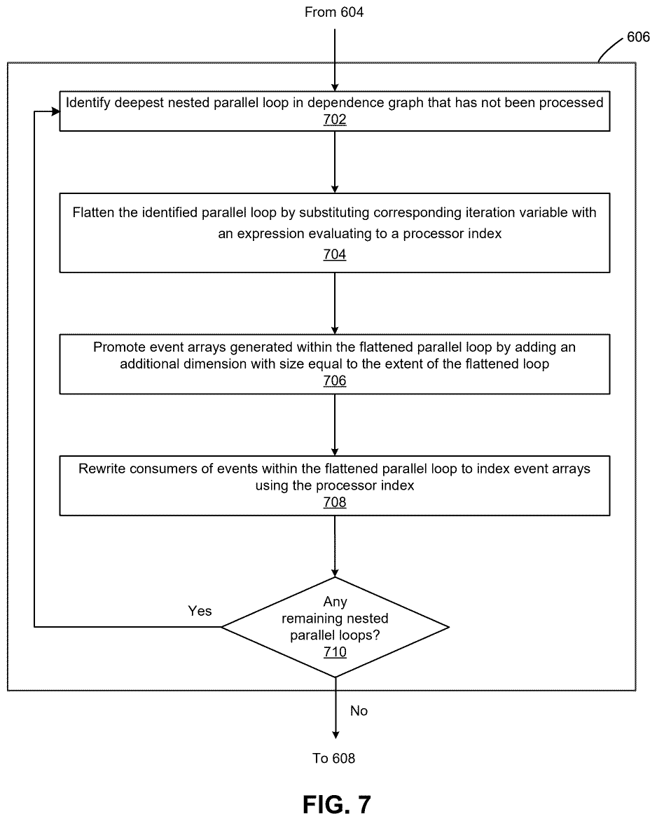

At step 606, vectorization 412 flattens parallel loops in the first dependence graph and generates a second dependence graph through a vectorization transformation. Vectorization 412 begins by locating the deepest parallel loops generated by dependence analysis 410 and substituting iteration variables with expressions that evaluate to hardware-specific processor identifiers such as the warp or thread index. Once implicit loops are flattened, each array of events is promoted by adding a new dimension sized to match the extent of the flattened loop, thereby indexing each array of events according to the processor index. The resulting array of events structure enables distinct tasks in separate iterations to continue operating with local dependencies, while shared dependencies are maintained for synchronization. Step 606 is discussed in greater detail below in conjunction with FIG. 7.

At step 608, copy elimination 414 identifies and removes one or more copy operations from the second dependence graph generated at step 606 to form a third dependence graph. Copy elimination 414 utilizes different patterns to remove redundant copy operations. In some embodiments, one pattern merges redundant copies into a single operation, preventing duplicate transfers from occupying shared or global memory. In such cases, another pattern, referred to as spill elimination, identifies instances in which a parent buffer slice is immediately transferred back to a child buffer. Copy elimination 414 removes or relocates copy operations outside loop constructs, provided the underlying data remains unchanged. Furthermore, in some embodiments, a self-copy elimination pattern bypasses transfers that rewrite the same buffer with no updates, but ensures that any event arrays governing synchronization remain valid.

At step 610, resource allocation 416 allocates memory to data objects in the third dependence graph. Resource allocation 416 frequently targets on-chip shared memory in each streaming processor, satisfying strict capacity constraints within such memory regions. In addition, resource allocation 416 balances the demand for memory with the benefits of parallelism, compelling a decision on whether certain tensors can share physical addresses. In some embodiments, shared memory usage corresponds to static random-access memory (SRAM) within SM 310, with the crossbar unit 210 managing data movement between PP memory 204 and DRAM 220. A level of aliasing can be used to accommodate large tiles needed by fixed-function units, but excessive aliasing can diminish concurrency.

At step 612, warp specialization 418 assigns sub-graphs of the third dependence graph to one or more warps, to increase concurrency and distribute hardware resources effectively. Warp specialization 418 can receive instructions from mapping specifications 406 to separate data movement tasks such as asynchronous transfers from global to shared memory from compute-intensive tasks, thereby preventing interference between functional units, for example, a tensor memory accelerator and a tensor core. Compiler 408 implements warp specialization 418 as a partitioning of the dependence graph, routing global to shared copies to a dedicated data movement warp and assigning other computations to one or more compute warps. Any dependencies crossing from the data movement warp to the compute warps appear as explicit barriers to ensure consistent usage of shared memory buffers. In some embodiments, a pipelining strategy further mitigates latency by unrolling loops in the dependence graph to a specified depth, allowing the data movement warp to stay multiple iterations ahead of compute warps.

At step 614, code generation 420 generates low-level code based on the sub-graphs in the third dependence graph. In some embodiments, the IR can be lowered onto hardware-specific synchronization primitives on a GPU. In such cases, code generation 420 can use a set of rules to convert at least part of the sub-graphs to function calls in the low-level code. In some embodiments, the generated code includes synchronization instructions, explicit copies, memory allocation directives, and/or warp-level parallelism in a statically analyzable framework. The compiler 408 generates code in a low-level language, such as CUDA C++, enabling deployment onto GPUs or other parallel accelerators with minimal runtime overhead.

FIG. 7 is a flow diagram illustrating method steps for vectorizing nested parallel loops at step 606 of method 600, according to various embodiments. In some embodiments, step 606 can be performed on an IR resulting from dependence analysis 410, which is performed at step 604 of method 600. Although the method steps are described in conjunction with the systems of FIGS. 1-4, persons skilled in the art will understand that any system configured to perform the method steps in any order falls within the scope of the present embodiments.

As shown, at step 702, vectorization 412 identifies the deepest nested parallel loop in the dependence graph generated by dependence analysis 410 that has not yet been processed. Vectorization 412 locates pfor constructs corresponding to warpgroups, warps, or threads, recognizing that flattening such loops can expose more concurrency. By selecting the innermost loop first, the transformation proceeds from the most granular level of parallel iteration outward.

At step 704, vectorization 412 flattens the identified loop by substituting the iteration variable with an expression evaluating to a hardware-specific processor index, for example, warpidx or threadidx. Instead of maintaining an abstract loop construct, each iteration is associated directly with a processor identifier, converting implicit iteration boundaries into explicit references to the GPU architecture. The expression evaluating to a processor index substitution preserves ordering constraints and parallel semantics while removing the loop from the event-based IR.

At step 706, vectorization 412 promotes any event arrays generated inside the newly flattened loop by adding a dimension with size equal to the extent of the flattened loop. Vectorization 412 expands each event array to track the completion events across all iterations. Consequently, consumers or producers that operate on the events can broadcast or index correctly without losing the original parallel structure of the dataflow.

At step 708, vectorization 412 re-writes consumers of events within the flattened parallel loop to index the promoted event arrays with the processor index. Each parallel iteration references event elements corresponding to the hardware identifier of event elements, providing point-wise dependencies when necessary. Broadcast operators remain in place for collective synchronization if mandated by the computation. The resulting dataflow preserves local dependencies for each processor separately, and shared dependencies remain in place for global barriers.

At step 710, vectorization 412 determines whether additional nested parallel loops remain in the dependence graph. If another unprocessed parallel loop exists (710—Yes), then method 600 returns to step 702 to continue the vectorization process. If no further loops remain (710—No), then method 600 proceeds to step 608 in the method 600, where copy elimination 414 or other transformations can operate on a flattened parallel loop representation.

In sum, techniques are disclosed for translating task-based programs into code that is optimized for execution on asynchronous accelerators within a processor. In some embodiments, a compiler identifies data dependencies within program code, performs a vectorization pass to flatten nested loops to improve parallelism, and arranges computations and data transfers into streamlined pipelines. First, the compiler performs dependence analysis to construct a directed graph that encodes read-write relationships, memory placements, and required ordering among tasks. The compiler performs vectorization using the directed graph to eliminate parallel loops by converting iterative constructs into explicit references for thread or warp-level concurrency. The compiler performs copy elimination to remove and/or merge redundant data transfers, minimizing unnecessary data movement. Then, the compiler performs resource allocation to assign physical memory addresses to logical data structures according to constraints specified by a user. Thereafter, the compiler performs warp specialization to subdivide the directed graph across multiple warps, introduce synchronization points when necessary, and designate particular warps to invoke fixed-function accelerators for matrix multiplication or data movement. Finally, the compiler performs code generation from the subdivided directed graph to produce code including a sequence of operations, integrating relevant library calls and synchronization instructions, while maintaining near-peak utilization of available hardware resources.

One technical advantage of the disclosed techniques over prior approaches is that the disclosed techniques reduce the need for developers to manually manage asynchronous operations and communications within a processor. At the same time, the disclosed techniques enable task-based programming, in which programs are written as sets of designated functions, thereby providing developers with a higher degree of control over how code executes than is permitted by conventional high-level compilers. As a result, developers can focus on applications and objectives at a higher abstraction level, while still achieving performance close to hardware limits. Yet another technical advantage is that the disclosed techniques simplify the computational overhead associated with resource allocation and synchronization in programming. By mapping computations onto hardware resources and handling synchronization, computational loads can be reduced and better preserved for application-specific tasks. By placing synchronization points and data copy instructions, the disclosed techniques reduce low-level coordination burdens and accelerate integration with specialized hardware architectures through selective partitioning or warp assignments. As a result, the disclosed techniques enhance code reliability and improve overall execution efficiency compared to prior art approaches. These technological advantages represent one or more technological advancements over prior art approaches.
1. In some embodiments, a computer-implemented method for compiling program code comprises receiving first program code, generating a first dependence graph based on the first program code, removing one or more parallel loops in the first dependence graph to generate a second dependence graph, removing one or more copy operations from the second dependence graph to generate a third dependence graph, allocating memory to one or more data objects in the third dependence graph, assigning one or more sub-graphs of the third dependence graph to one or more corresponding warps, and generating second program code based on the one or more sub-graphs of the third dependence graph.
2. The computer-implemented method of clause 1, wherein the first program code specifies one or more tasks.
3. The computer-implemented method of clauses 1 or 2, wherein generating the first dependence graph comprises performing a dependence analysis to identify one or more relationships between different portions of the first program code.
4. The computer-implemented method of any of clauses 1-3, wherein removing the one or more parallel loops comprises, for a first parallel loop included in the one or more parallel loops flattening the first parallel loop by substituting a corresponding iteration variable with an expression evaluating to a processor index to generate a flattened loop, promoting one or more event arrays generated within the first parallel loop by adding a dimension with size equal to an extent of the flattened loop to generate one or more promoted event arrays, and modifying one or more consumers of events within the first parallel loop to index the one or more promoted event arrays using the processor index.
5. The computer-implemented method of any of clauses 1-4, wherein removing the one or more copy operations comprises removing a first copy operation while preserving one or more dependencies in the second dependence graph that are associated with the first copy operation.
6. The computer-implemented method of any of clauses 1-5, wherein removing the one or more copy operations comprises removing a first copy and removing one or more dependencies in the second dependence graph that are associated with the first copy operation.
7. The computer-implemented method of any of clauses 1-6, further comprising receiving a user-specified amount of memory to use, wherein allocating memory to the one or more data objects is based on the user-specified amount of memory.
8. The computer-implemented method of any of clauses 1-7, wherein allocating memory to the one or more data objects comprises minimizing a number of aliasing memory allocations.
9. The computer-implemented method of any of clauses 1-8, wherein generating the second program code comprises converting one or more portions of the one or more sub-graphs into one or more function calls in the second program code.
10. The computer-implemented method of any of clauses 1-9, wherein removing the one or more parallel loops comprises, for a first parallel loop included in the one or more parallel loops upcasting one or more events in the first parallel loop to a size associated with a warp, and modifying one or more consumers of events in the first parallel loop to depend on one or more producers of events in the warp.
11. In some embodiments, one or more non-transitory computer-readable media store instructions that, when executed by at least one processor, cause the at least one processor to perform the steps of receiving first program code, generating a first dependence graph based on the first program code, removing one or more parallel loops in the first dependence graph to generate a second dependence graph, removing one or more copy operations from the second dependence graph to generate a third dependence graph, allocating memory to one or more data objects in the third dependence graph, assigning one or more sub-graphs of the third dependence graph to one or more corresponding warps, and generating second program code based on the one or more sub-graphs of the third dependence graph.
12. The one or more non-transitory computer-readable media of clause 11, wherein the first program code specifies one or more tasks.

13. The one or more non-transitory computer-readable media of clauses 11 or 12, wherein generating the first dependence graph comprises performing a dependence analysis to identify one or more relationships between different portions of the first program code.
14. The one or more non-transitory computer-readable media of any of clauses 11-13, wherein removing the one or more parallel loops comprises, for a first parallel loop included in the one or more parallel loops upcasting one or more events in the first parallel loop to a size associated with a warp, and modifying one or more consumers of events in the first parallel loop to depend on one or more producers of events in the warp.
15. The one or more non-transitory computer-readable media of any of clauses 11-14, wherein removing the one or more copy operations comprises removing a first copy operation while preserving one or more dependencies in the second dependence graph that are associated with the first copy operation.
16. The one or more non-transitory computer-readable media of any of clauses 11-15, wherein removing the one or more copy operations comprises removing a first copy and removing one or more dependencies in the second dependence graph that are associated with the first copy operation.
17. The one or more non-transitory computer-readable media of any of clauses 11-16, wherein the second program code is structured for execution on a graphics processing unit (GPU).
18. The one or more non-transitory computer-readable media of any of clauses 11-17, wherein the first program code comprises code for a machine learning kernel operation.
19. The one or more non-transitory computer-readable media of any of clauses 11-18, wherein the first program code comprises code for a general matrix multiply (GEMM) operation.
20. In some embodiments, a system comprises a memory storing instructions, and one or more processors, that when executing the instructions, are configured to perform the steps of receiving first program code, generating a first dependence graph based on the first program code, removing one or more parallel loops in the first dependence graph to generate a second dependence graph, removing one or more copy operations from the second dependence graph to generate a third dependence graph, allocating memory to one or more data objects in the third dependence graph, assigning one or more sub-graphs of the third dependence graph to one or more corresponding warps, and generating second program code based on the one or more sub-graphs of the third dependence graph.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system. ” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for compiling program code, the method comprising:
receiving first program code;
generating a first dependence graph based on the first program code;
removing one or more parallel loops in the first dependence graph to generate a second dependence graph;
removing one or more copy operations from the second dependence graph to generate a third dependence graph;
allocating memory to one or more data objects in the third dependence graph;
assigning one or more sub-graphs of the third dependence graph to one or more corresponding warps; and
generating second program code based on the one or more sub-graphs of the third dependence graph.

2. The computer-implemented method of claim 1, wherein the first program code specifies one or more tasks.

3. The computer-implemented method of claim 1, wherein generating the first dependence graph comprises performing a dependence analysis to identify one or more relationships between different portions of the first program code.

4. The computer-implemented method of claim 1, wherein removing the one or more parallel loops comprises, for a first parallel loop included in the one or more parallel loops:
flattening the first parallel loop by substituting a corresponding iteration variable with an expression evaluating to a processor index to generate a flattened loop;
promoting one or more event arrays generated within the first parallel loop by adding a dimension with size equal to an extent of the flattened loop to generate one or more promoted event arrays; and
modifying one or more consumers of events within the first parallel loop to index the one or more promoted event arrays using the processor index.

5. The computer-implemented method of claim 1, wherein removing the one or more copy operations comprises removing a first copy operation while preserving one or more dependencies in the second dependence graph that are associated with the first copy operation.

6. The computer-implemented method of claim 1, wherein removing the one or more copy operations comprises removing a first copy and removing one or more dependencies in the second dependence graph that are associated with the first copy operation.

7. The computer-implemented method of claim 1, further comprising receiving a user-specified amount of memory to use, wherein allocating memory to the one or more data objects is based on the user-specified amount of memory.

8. The computer-implemented method of claim 1, wherein allocating memory to the one or more data objects comprises minimizing a number of aliasing memory allocations.

9. The computer-implemented method of claim 1, wherein generating the second program code comprises converting one or more portions of the one or more sub-graphs into one or more function calls in the second program code.

10. The computer-implemented method of claim 1, wherein removing the one or more parallel loops comprises, for a first parallel loop included in the one or more parallel loops:
upcasting one or more events in the first parallel loop to a size associated with a warp; and
modifying one or more consumers of events in the first parallel loop to depend on one or more producers of events in the warp.

11. One or more non-transitory computer-readable media storing instructions that, when executed by at least one processor, cause the at least one processor to perform the steps of:
receiving first program code;
generating a first dependence graph based on the first program code;
removing one or more parallel loops in the first dependence graph to generate a second dependence graph;
removing one or more copy operations from the second dependence graph to generate a third dependence graph;
allocating memory to one or more data objects in the third dependence graph;
assigning one or more sub-graphs of the third dependence graph to one or more corresponding warps; and
generating second program code based on the one or more sub-graphs of the third dependence graph.

12. The one or more non-transitory computer-readable media of claim 11, wherein the first program code specifies one or more tasks.

13. The one or more non-transitory computer-readable media of claim 11, wherein generating the first dependence graph comprises performing a dependence analysis to identify one or more relationships between different portions of the first program code.

14. The one or more non-transitory computer-readable media of claim 11, wherein removing the one or more parallel loops comprises, for a first parallel loop included in the one or more parallel loops:
upcasting one or more events in the first parallel loop to a size associated with a warp; and
modifying one or more consumers of events in the first parallel loop to depend on one or more producers of events in the warp.

15. The one or more non-transitory computer-readable media of claim 11, wherein removing the one or more copy operations comprises removing a first copy operation while preserving one or more dependencies in the second dependence graph that are associated with the first copy operation.

16. The one or more non-transitory computer-readable media of claim 11, wherein removing the one or more copy operations comprises removing a first copy and removing one or more dependencies in the second dependence graph that are associated with the first copy operation.

17. The one or more non-transitory computer-readable media of claim 11, wherein the second program code is structured for execution on a graphics processing unit (GPU).

18. The one or more non-transitory computer-readable media of claim 11, wherein the first program code comprises code for a machine learning kernel operation.

19. The one or more non-transitory computer-readable media of claim 11, wherein the first program code comprises code for a general matrix multiply (GEMM) operation.

20. A system, comprising:
a memory storing instructions; and
one or more processors, that when executing the instructions, are configured to perform the steps of:
receiving first program code,
generating a first dependence graph based on the first program code,
removing one or more parallel loops in the first dependence graph to generate a second dependence graph,
removing one or more copy operations from the second dependence graph to generate a third dependence graph,
allocating memory to one or more data objects in the third dependence graph,
assigning one or more sub-graphs of the third dependence graph to one or more corresponding warps, and
generating second program code based on the one or more sub-graphs of the third dependence graph.
